(19) United States
(12) Patent Application Publication
(10) Pub. No.: US 2006/0047983 A1
(43) Pub. Date: Mar. 2, 2006

(54) Multiple source/multiple device connector

(76) Inventors: Zeev Aleyraz, Herzelliya (IL); Shemuel Gal, Hadera (IL); Gennadi Finkelshtain, Shoham (IL)

Correspondence Address: GREENBLUM & BERNSTEIN, P.L.C., 1950 ROLAND CLARKE PLACE, RESTON, VA, 20191, US

(21) Appl. No.: 11/132,203

(22) Filed: May 19, 2005

Related U.S. Application Data
(60) Provisional application No. 60/572,235, filed on May 19, 2004.

(51) Int. Cl. G06F 1/26

(52) U.S. Cl. 713/300

(57) ABSTRACT

Apparatus and process to couple a power source to a powered device. The apparatus includes a power manager structured and arranged to adjust at least one of voltage, current and power supplied from the power source to the powered device based upon consumption requirements of the powered device, and a device coordinator structured and arranged to identify the powered device and to forward the identified device's consumption requirements for at least one of voltage, current and power to the power manager. The instant abstract is neither intended to define the invention disclosed in this specification nor intended to limit the scope of the invention in any way.

### CROSS-REFERENCE TO RELATED APPLICATIONS

The present application claims benefit under 35 U.S.C. § 119(e) of U.S. Provisional Patent Application No. 60/572,235 filed May 19, 2004, the disclosure of which is expressly incorporated by reference herein in its entirety.

### BACKGROUND OF THE INVENTION

1. Field of the Invention

The present invention is directed to an apparatus to couple any of a number of power sources (ac or dc) to any of a number of powered devices, e.g., small mobile equipment (laptop/notebook, digital camera, handheld, cellular phone, video camera, etc.).

2. Discussion of Background Information

U.S. Pat. No. 5,347,211 is directed to a selectable output power converter for providing a selectable desired voltage. The converter includes a converter circuit that receives a predetermined input voltage and delivers a (selectable output voltage to a coupled device. The converter circuit also includes a keyway for receiving a key having a body within which an electrical component is disposed. The output voltage of the converter is selected by the value of the electrical component within the body of the key. In this manner, the output voltage can be varied by replacing the key with another key having an electrical component of a different value.

### SUMMARY OF THE INVENTION

The present invention is directed to an apparatus to couple any of a number of power sources (ac or dc) to any of a number of powered devices, e.g., small mobile equipment (laptop/notebook, digital camera, handheld, cellular phone, video camera, etc.), so that power consumption requirements for the powered devices are maintained with any input source.

In accordance with the invention, the apparatus “identifies” the powered device and selects the appropriate power, voltage, and/or current levels to operate the identified device. The powered device is identified via alternative procedures, e.g., blue tooth, IR, SM bus, internal UART/RS-232, internal dig switch, and/or EPROM device interface plug-in.

A number of plug-in connectors may be available to connect the powered device to the apparatus. Moreover, the specific powered device (manufacturer and model number) determines which of the plug-in connectors should be employed to couple the powered device to the apparatus. In this regard, the arrangement of pins on the plug that attaches to the plug port on the MSMD-PS forms a code read by the EPROM to identify the specific powered device.

The apparatus determines what powered device is plugged in and suits the power source to the determined device. Upon identifying the powered device, the apparatus automatically supplies the correct power for charging or for operation as the main power source.

According to the invention, the proper output power for use with any connected powered device is matched with any available input power source. The output power can be adjusted as a secondary power source for continued charging or as a main power source depending upon the input source versus the current output, which is determined by the device specification of the connected powered device

The present invention is directed to an apparatus to couple a power source to a powered device that includes a power manager structured and arranged to adjust at least one of voltage, current and power supplied from the power source to the powered device based upon consumption requirements of the powered device, and a device coordinator structured and arranged to identify the powered device and to forward the identified device's consumption requirements for at least one of voltage, current and power to the power manager.

In accordance with a feature of the invention, the apparatus can include a plurality of communications ports. The powered device may be coupled to the device coordinator through the plurality of communications ports. The communications ports can receive communication via at least one of infrared, bluetooth, SM-bus, RS-232, USB, and digital switch. Further, the powered device is automatically identified through use of the SM-bus.

According to another feature of the invention, the apparatus can include at least one plug connector to couple the device coordinator to the powered device. An encoded plug is insertable into the at least one plug connector. In this manner, decoding of the plug by the device coordinator automatically identifies the powered device.

According to still another feature of the present invention, the power source can be at least one of an ac power source and a dc power source.

Further, the powered device can include a mobile equipment. The mobile equipment may include at least one of a laptop/notebook computer, digital camera, personal digital assistant (PDA), cellular telephone, and video camera.

In accordance with a further feature of the present invention, the power manager can include a dc/dc converter structured and arranged to adjust at least one voltage and current from the power supply to be supplied to the powered device. The power manager may also include an up converter structured and arranged to boost at least one of voltage and current from the dc/dc converter to be supplied to the powered device. Moreover, the power manager may include a backup battery to supply additional power to the powered device when necessary to supplement the power supply, as well as an up converter structured and arranged to boost the output of the backup battery to the powered device.

The instant invention is directed to a process for supplying at least one of voltage, current and power from a power supply to a powered device. The process includes coupling the power supply and powered device through a connection device, identifying consumption requirements of the powered device through communication between the powered device and the connection device, and adjusting the at least one of voltage, current and power supplied by the power source to the powered device in accordance with the consumption requirements.

According to a feature of the invention, the communication between the powered device and the connection device can be through one of infrared, bluetooth, SM-bus, RS-232, USB, and digital switch. The powered device is automatically identified through use of the SM-bus.

Further, the communication between the powered device and the connection device may be is through an encoded plug that automatically identifies the powered device.

According to another feature of the invention, the power source can be at least one of an ac power source and a dc power source.

In accordance with still yet another feature of the present invention, a process for connecting a power supply to a powered device through the above-described apparatus includes coupling the power supply and powered device through the power manager, identifying consumption requirements of the powered device through communication between the powered device and the device coordinator, and adjusting, via the power manager, at least one of voltage, current and power supplied by the power source to the powered device in accordance with the consumption requirements identified by the device coordinator.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically illustrates an apparatus for connect multiple sources to multiple powered devices in accordance with the instant invention;

FIG. 2 schematically illustrates the power source section of the apparatus depicted in FIG. 1;

FIG. 3 schematically illustrates the device coordinator of the apparatus depicted in FIG. 1;

FIG. 4 schematically illustrates the power management module of the apparatus depicted in FIG. 1;

FIGS. 5-12 graphically illustrate an exemplary procedure for operating the apparatus depicted in FIG. 1.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

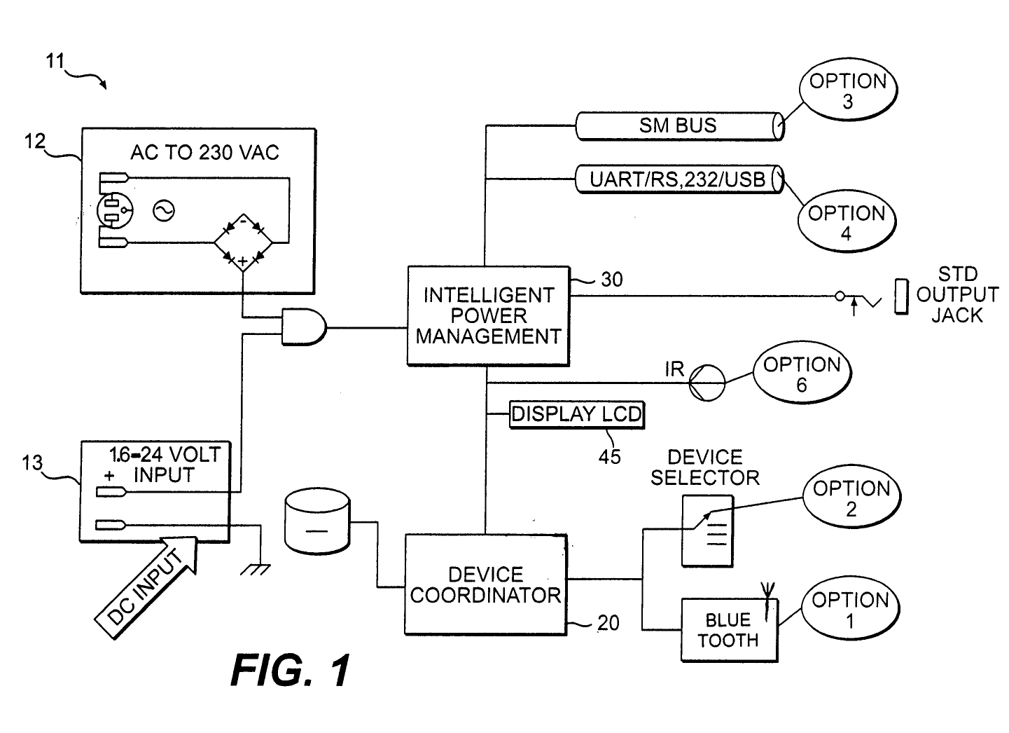

The present invention, as illustrated in FIG. 1, is directed to a connector (adapter) 10 structured to couple any of multiple power sources (ac or dc) to any of multiple powered devices, such as small mobile equipment (e.g., laptop/notebook, digital camera, handheld, cellular phone, video camera, etc.). Connector 10 includes an input section 11 having an ac input 12 and a dc input 13. The ac input 12 is couplable to any ac source and has a maximum input of 40 W with a range of 90V-230V/ac, while the dc input 13 is couplable to regular known batteries to provide an input dc range between 0.5V and 24V. The regular known batteries include, but are not limited to, rechargeable and non-rechargeable batteries (e.g., sizes AA, AAA, B, C, D, etc.), special cellular battery, fuel cell power pack, vehicle internal battery (12V), boat internal battery (24V), and aircraft (24V/115VAC 400 Hz). However, it is understood that new power sources and devices can be adapted for use with connector 10 without departing from the spirit of the invention. Inputs 12 and 13 are coupled to an AND gate, whereby, when an ac source is connected, the dc section is automatically disconnected in order to preserve battery life.

Connector 10 also includes a device coordinator 20 that determines what powered device is coupled to connector 10 and informs a power management module 30 of the appropriate voltages to supply to the powered device. Device coordinator can include a number of communications ports, e.g., blue tooth transmitter/receiver, COM port/RS-232, UART, USB port, Infrared transmitter/receiver, and SM bus communication port, and a plug jack.

Power management module 30 is coupled between input source 11 and an output 40, which is coupled to the powered device. Moreover, power management module 30 is coupled to device coordinator 20 to receive the power requirements of the identified powered device and to supply the appropriate power to the attached device.

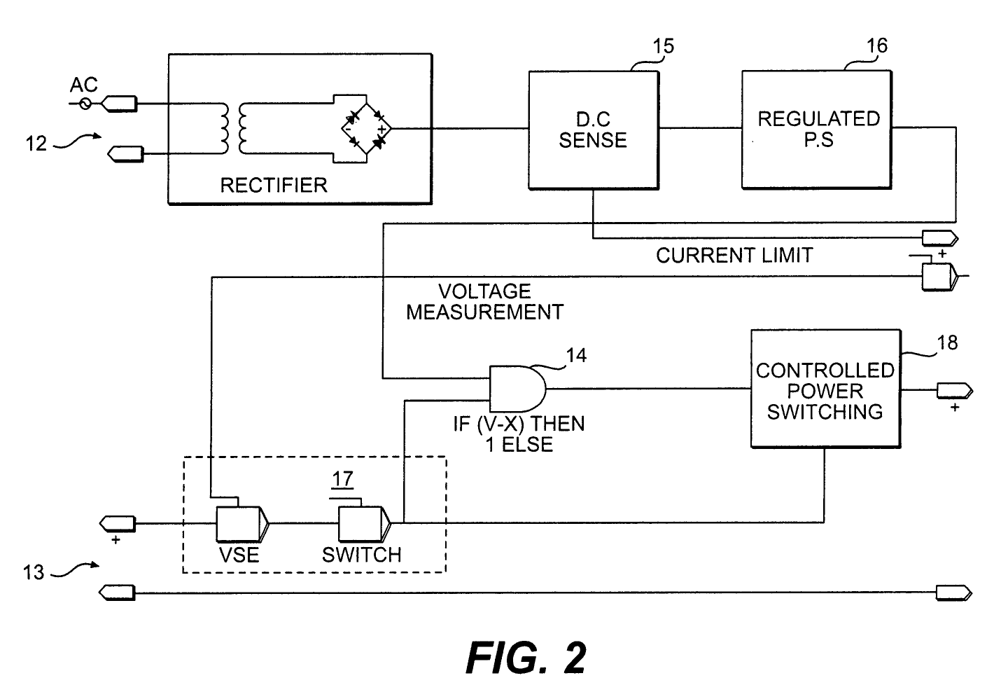

Input section 11 is illustrated in greater detail with reference to FIG. 2. In particular, ac input 12 is coupled to a dc sensing device 15, in which the supplied current is limited based upon the identity of the powered device, i.e., by device coordinator 20, and dc sensing device 15 is supplied to regulated power supply 16. The output of regulated power supply 16 is coupled to an input of AND gate 14. The dc input 13 measures input voltage at V SE and includes a switch 17 that automatically disconnects the dc section when an ac source is connected. When only a dc source is connected, the voltage measurement will decide how to act in accordance with the device identified by the coordinator. The dc input 14 is coupled to the other input of AND gate 14. The output of AND gate 14 is coupled to a controlled power switching device 18 that couples the power supply to power management module 30.

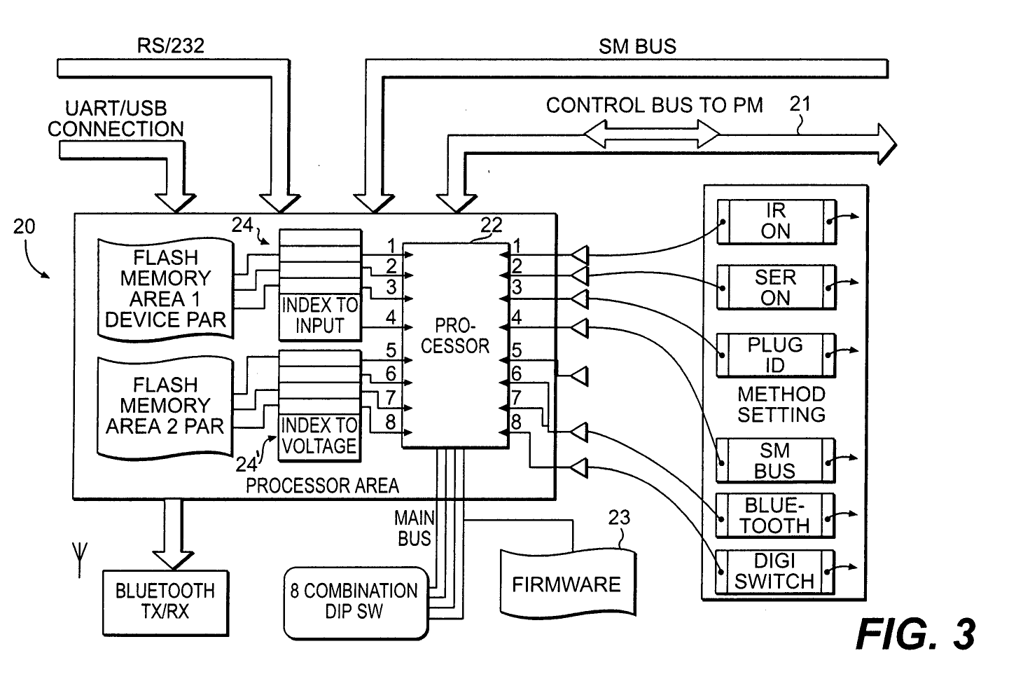

As illustrated in FIG. 3, device coordinator 20 is coupled to power management module 30 through control bus 21. A processor 22 is coupled to the communications ports and the plug jack and to firmware 23 for identifying the attached powered device. Firmware 23 can be stored in a basic memory device or on a flash memory. Moreover, processor 22 is coupled to indexes 24 and 24′ in order to obtain the appropriate power level to be supplied to the identified device, which is forwarded to power management module 30 over control bus 21. Flash memory areas 25 and 25′ are provided for storing information for various powered devices, and, as new powered devices become available, the information and power requirements for these new devices can likewise be stored for access by device coordinator 20. The stored/retrieved information can include data about the limits characteristics for input voltage and current limit for every stored device.

Once the powered device is coupled to connector 10 through a communications port or plug jack, the user must set the proper setting for maximum reliability and safe input voltage. To identify the powered device, the powered device can be connected to device coordinator 20 through an IR interface, which gives a user connection for setting and determining which device is connected, or via bluetooth which can provide proper connection through a simple protocol. Moreover, the powered device can be identified through an internal dig switch, or an internal UART/RS-232. Connection to these devices will provide an interface to connector 10 with proper application and give the user the possibilities to select the correct powered device. In an exemplary embodiment, the identified powered device can be displayed to the user, e.g., via a display 45, such as an LCD, so that user interface can provide the proper settings for the device. However, when the powered device is connected to device coordinator 20 through an SM bus, the device will be automatically selected, i.e., without requiring user interface, i.e., the device will be set as a target on the display.

Still further, the powered device can be coupled to the device coordinator 20 though an EPROM device interface plug-in. The specific powered device (manufacturer and model number) determines which of the plug-in connectors should be utilized in coupling the powered device and device coordinator 20. In this regard, the arrangement of pins on the plug that attaches to the plug port for the device coordinator 20 forms a unique code read by the EPROM to identify the specific powered device. For example, the code in the plug can be provided by coupling certain pins high and certain to ground, whereby the EPROM reads the digital code and, thereafter, accesses the supply information for the identified powered device.

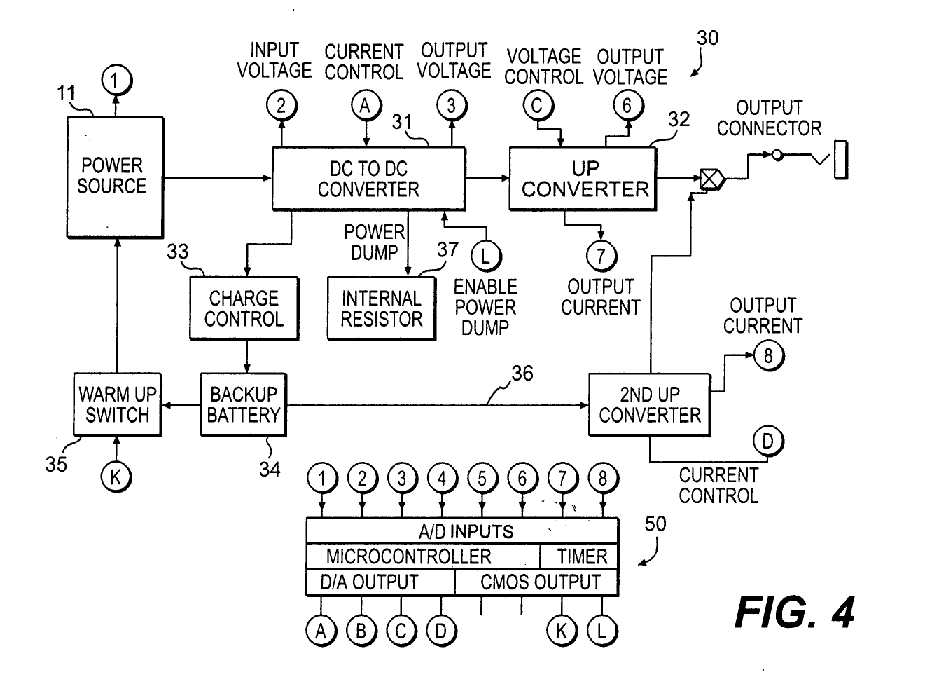

The power requirements for the identified powered device are forwarded, via control bus 21, to power management module 30, which is illustrated in greater detail in FIG. 4. Power source 11 is coupled to dc-to-dc (dc/dc) converter 31, which adjusts the voltage and current to levels required by the identified powered device. If an increase in levels above those achievable through dc/dc converter 31, an up converter 32, e.g., LTC3402 is arranged to further increase the voltage and/or current supplied to output 40. The output voltage in the exemplary embodiment is dc with a maximum 30 W (all ranges), however, as power requirements change in powered devices, the achievable output voltage can be increased in accordance with the teachings of the present disclosure without departing from the spirit of the invention. As shown, power source 11 forwards the power supply output voltage to A/D input 1 of processor 50, dc/dc converter 31 forwards its input and output voltages to A/D inputs 2 and 3 of processor 50, and output voltage and output current of up converter 32 is coupled to A/D inputs 6 and 7, respectively. Current control from D/A output A of processor 50 is input to dc/dc converter 31, and voltage control from D/A output C of processor 50 is coupled to up converter 32.

Additionally, dc/dc converter 31 is coupled to charge control device 33, which charges backup battery 34, in order to store excess energy to backup battery 34 while the backup battery is in a standby position. Backup battery 34 is coupled to a warm-up switch connected to power source 11 and to a second up converter, e.g., LTC3402, which is arranged to boost the voltage and/or current of the backup battery to ensure that the target power requirements are supplied to the powered device, in the event of loss of power or reduction in power from power source 11. CMOS output K of processor 50 is coupled to warm up switch 35 and ena current control from D/A output D of processor 50 is coupled to second up converter 36. Output current from second up converter 36 is coupled to A/D input 8 of processor 50.

Dc/dc converter 31 is coupled to an internal resistor for a power dump, which is enabled through a signal from CMOS output L of processor 50. When the powered device's consumption drops below a defined minimum current level, backup battery 34 is fully charged, and the output voltage from power supply 11 is greater than a predefined minimum, internal (dump) resistor is activated by processor 50 to consume a defined maximum power from dc/dc converter 31. Further, processor 50 can supply the dump complementary power in order to keep the dc/dc converter power consumption at no more than the defined maximum power. However, in the event that the voltage of backup battery 34 drops below a minimum defined value, processor 50 will stop any current consumption from backup battery 34.

According to an exemplary embodiment of the invention, short circuit protection can be indicated in display 45 and simultaneously in a specified LED color. Further, output voltage is protected based upon: short circuit protection, which determines short circuit as over current based on the powered device; current limit based on input power source; reversal voltage from the device connected to connector 10; regulated voltage configured to EMI, working device models and fast switching environment interference; and plug matching protection.

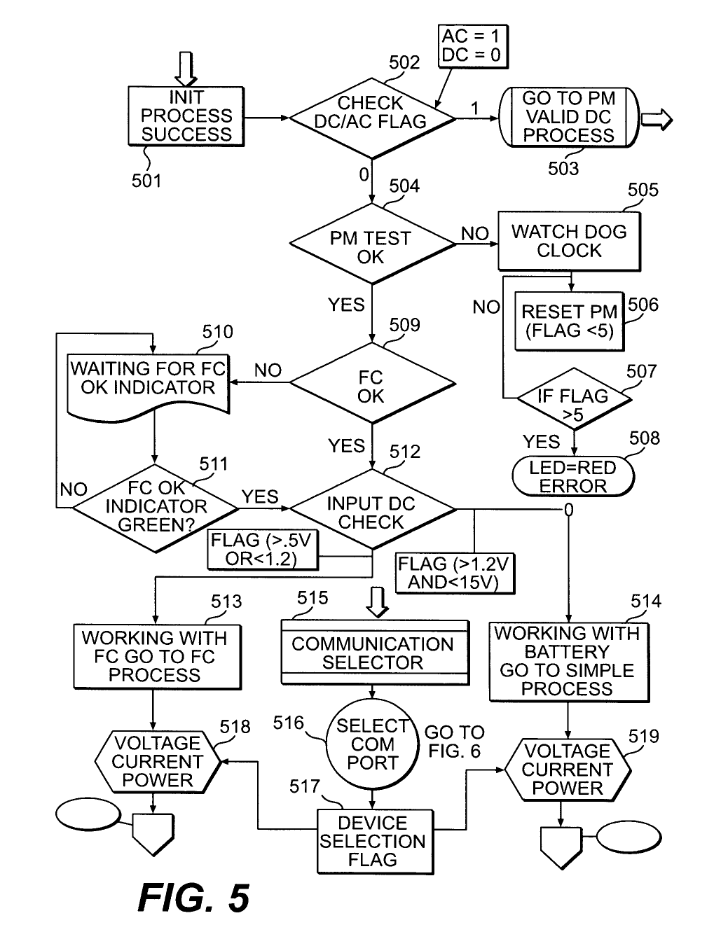

An exemplary embodiment of the operation of device coordinator 20 is graphically depicted in the flow diagrams of FIGS. 5-12. In FIG. 5, step 501 provides a signal to indicate that the process is being initialized. Step 502 determines whether the power source is ac or dc. When power source is ac, power management module 30 is informed in step 503 and power management module supplies the required voltage, current, and/or power to the powered device in accordance with the operating parameters of the identified powered device forwarded from device coordinator 20. When the power source is dc, power management module 30 is tested to ensure it is ready for operation at step 504. If the test is negative, a watch dog clock is activated in step 505 to reset power management module 30 in step 506. When the time expires in step 507, an error signal, e.g., illumination of a red LED, is activated and the process ends.

When the power management module test is positive, step 509 determines whether the battery/fuel cell is operating properly. If not, step 510 awaits an o.k. condition in step 511, whereupon an indication that the battery/fuel cell is operating properly is confirmed.

Once the operational status of the battery/fuel cell is confirmed, the dc input voltage is measured in step 512. When the voltage is less than 1.2, it is assumed that the dc power source is a fuel cell, and the process goes to step 513 to adapt the power supply from the fuel cell to drive the powered device. In this regard, fuel cell voltages generally have a voltage range between 0.5 V and 1.2 V. While the upper and lower extents of this range can vary, the instant invention can utilize these power sources for operating the identified powered device. When the voltage is greater than 1.2 V, it is assumed that the dc power source is a battery, and the process goes to step 514 to adapt the power supply from the battery to drive the powered device. Batteries generally exhibit a voltage range between 1.2 V and 15 V, however, boat batteries and aircraft batteries can exhibit a much higher voltage, e.g., 24 V, which the present invention can accommodate.

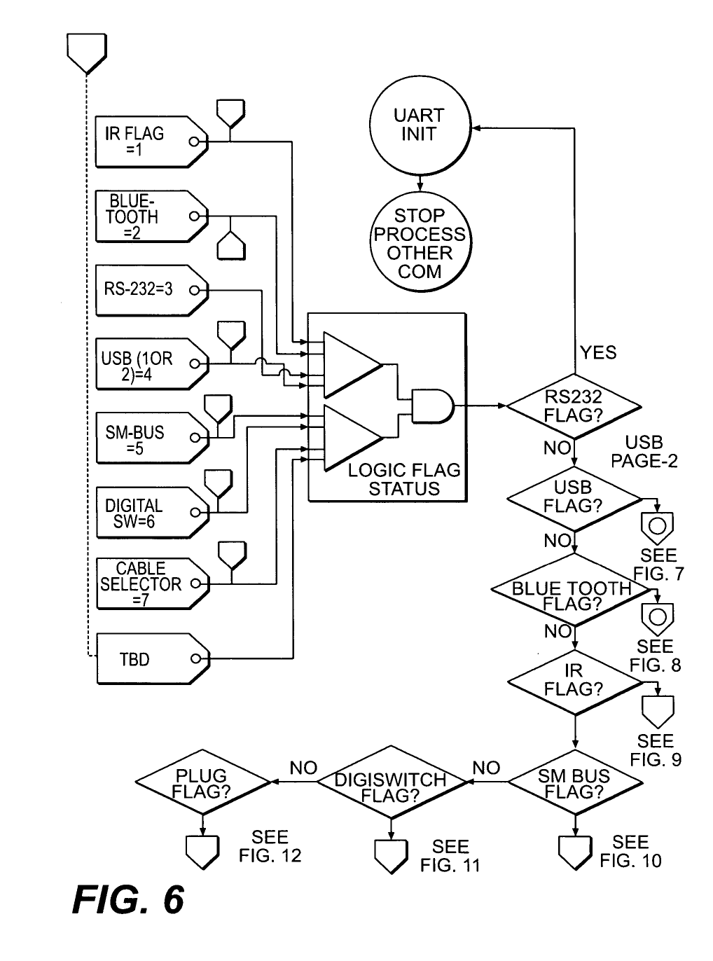

Step 515, which is separate from the process for identifying the power source, begins the process of identifying the powered device. In particular, step 516 selects the communications port from to which information about the powered device will be received. For further information regarding this portion of the process, refer to FIG. 6. As illustrated in FIG. 6, eight (8) communications ports are identified (including a port for communications in a not yet determined manner), and the process determines which of these ports the powered device is coupled to the powered device. In the exemplary illustration, the communications ports are individually queried to determine the coupled port. At step 601 the RS-232 port is queried. If the RS 232 port is coupled to the powered device, the UART is initialized in step 601 and the process is halted with regard to the other communications ports in step 602.

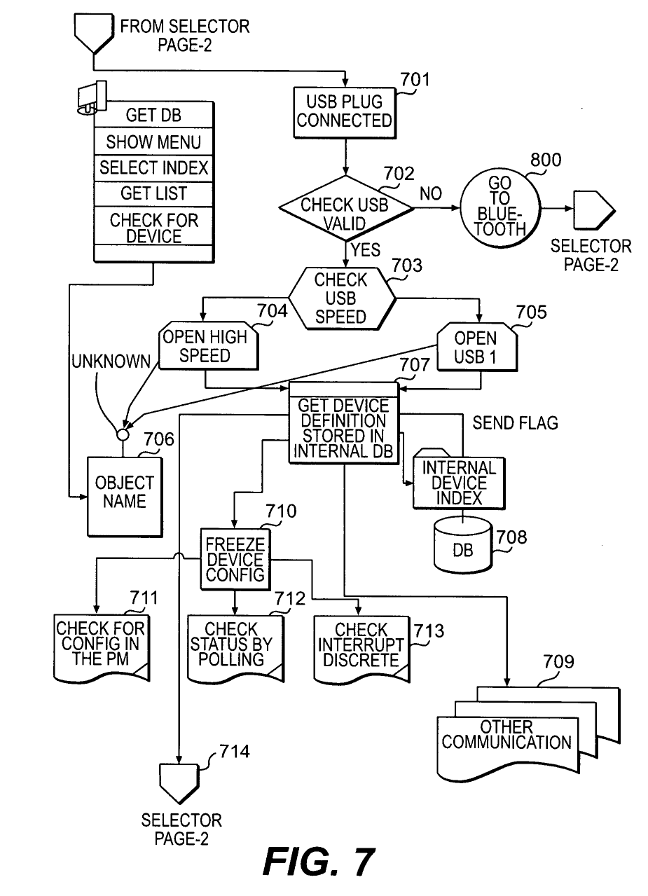

If the RS-232 port is not coupled to the powered device, the USB port is queried in step 603. The USB port query is graphically illustrated in FIG. 7. The USB plug is connected at step 701, and a query of whether USB is valid occurs at step 702. When the USB is valid, the USB speed is determined in step 703. Whether open high speed in step 704 or open USB1 in step 705, a request to identify the object (powered device) is made in step 706, which requires user interaction. The database is accessed and a menu is provided from which an index is selected by the user. A list is then provided from which the user selects the powered device. The identity of the powered device is forwarded in step 707 to obtain, through an internal device index, the definition stored in the database associated with the powered device in step 708. If necessary, it may be necessary to access other communications in step 709 in order to obtain the definition associated with the powered device. Step 710 freezes the device configuration, and checks for the configuration in power management module 30 in step 711, checks status by polling in step 712, and checks interrupt discrete in step 713. In step 714, the definition is forwarded to power management module 30 for adjusting the power, voltage and/or current levels of the power supply to correspond to the requirements of the powered device.

If the USB is not valid in step 702, the bluetooth port is queried in step 800.

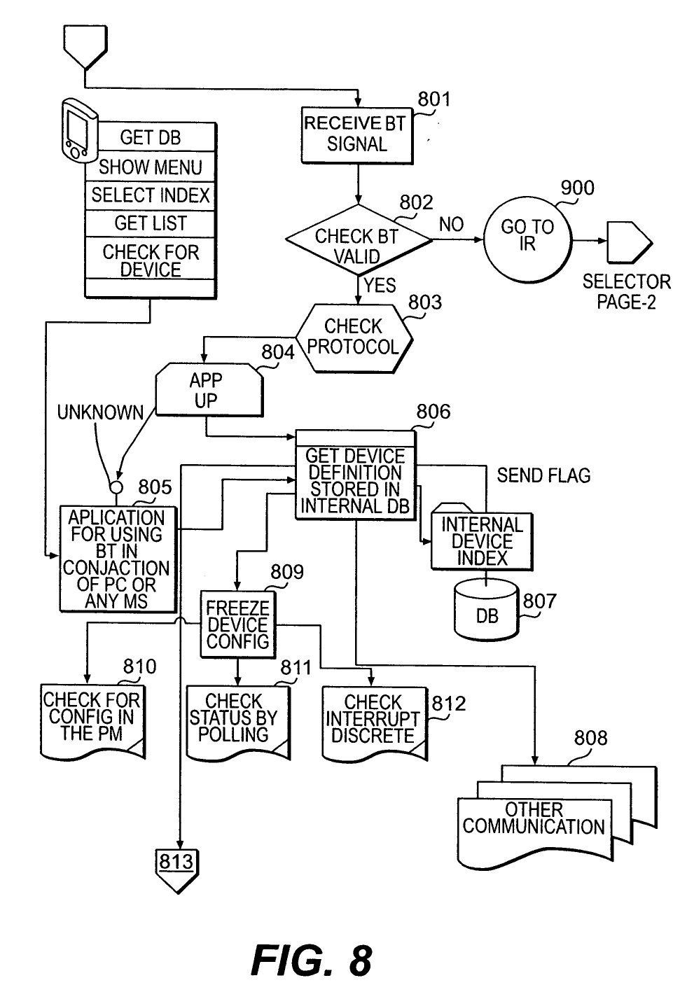

The bluetooth port query is graphically illustrated in FIG. 8. The bluetooth signal is received at step 801, and a query of whether bluetooth is valid occurs at step 802. When the bluetooth is valid, the bluetooth protocol is checked in step 803. An application is opened in step 804 into order to identify the object (powered device) in step 805, which requires user interaction. The database is accessed and a menu is provided from which an index is selected by the user. A list is then provided from which the user selects the powered device. The identity of the powered device is forwarded in step 806 to obtain, through an internal device index, the definition stored in the database associated with the powered device in step 807. It may be necessary to access other communications in step 808 in order to obtain the definition associated with the powered device. Step 809 freezes the device configuration, and checks for the configuration in power management module 30 in step 810, checks status by polling in step 811, and checks interrupt discrete in step 812. In step 813, the definition is forwarded to power management module 30 for adjusting the power, voltage and/or current levels of the power supply to correspond to the requirements of the powered device.

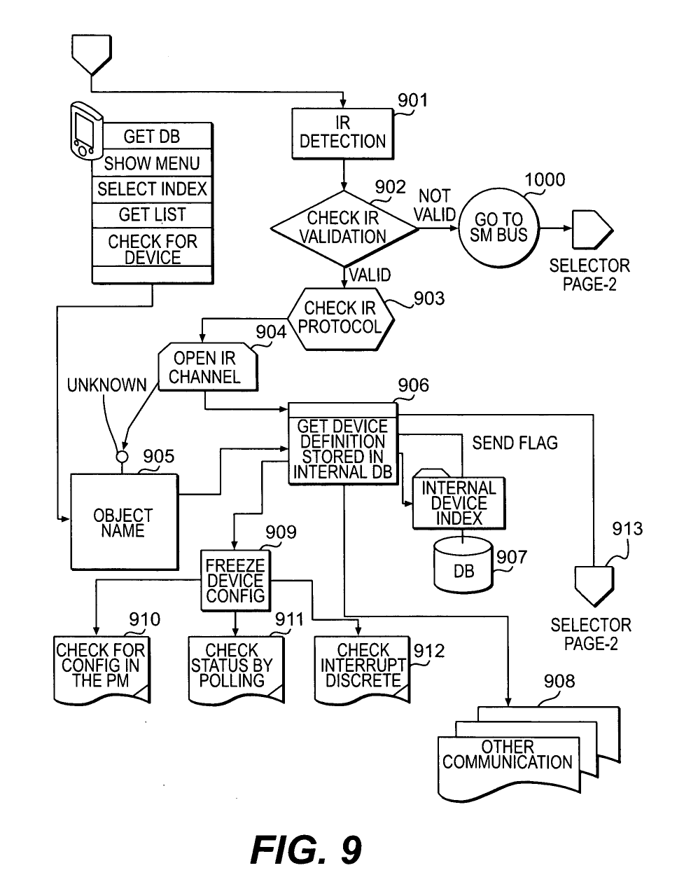

If bluetooth is not valid in step 802, the infrared (IR) port is queried in step 900. The IR port query is graphically illustrated in FIG. 9. The IR signal is received at step 901, and a query of whether IR is valid occurs at step 902. When the IR valid, the IR protocol is checked in step 903. An IR channel is opened in step 904 into order to identify the object (powered device) in step 905, which requires user interaction. The database is accessed and a menu is provided from which an index is selected by the user. A list is then provided from which the user selects the powered device. The identity of the powered device is forwarded in step 906 to obtain, through an internal device index, the definition stored in the database associated with the powered device in step 907. It may be necessary to access other communications in step 908 in order to obtain the definition associated with the powered device. Step 909 freezes the device configuration, and checks for the configuration in power management module 30 in step 910, checks status by polling in step 911, and checks interrupt discrete in step 912. In step 913, the definition is forwarded to power management module 30 for adjusting the power, voltage and/or current levels of the power supply to correspond to the requirements of the powered device.

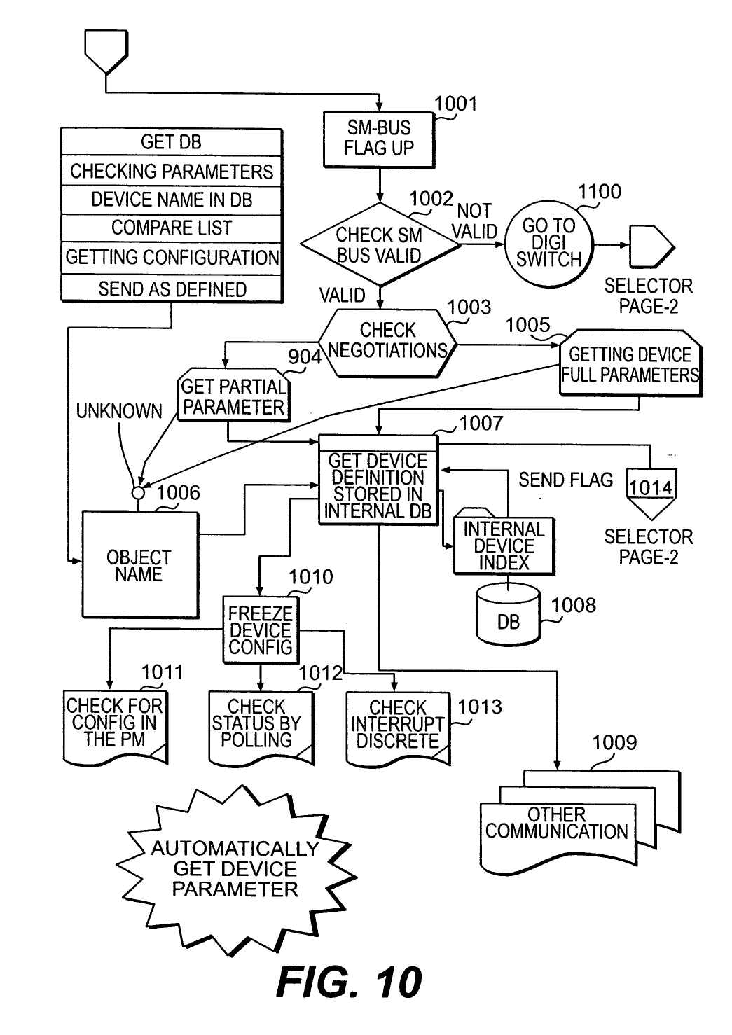

If IR is not valid in step 902, the SM-bus is queried in step 1000. The SM-bus query is graphically illustrated in FIG. 10. The SM-bus signal is received at step 1001, and a query of whether SM-bus is valid occurs at step 1002. When the SM-bus is valid, the SM-bus negotiation is checked in step 1003. Whether getting partial parameter in step 1004 or getting device full parameters in step 1005, a request to identify the object (powered device) is made in step 1006, which is automatically obtained without requiring user interaction. The database is accessed and the device parameters are checked. The device name is found in the database and a compare list is obtained to get the configuration for the device, which is sent, in step 1007, to obtain, through an internal device index in step 1008, the definition stored in the database associated with the identified powered device. It may be necessary to access other communications in step 1009 in order to obtain the definition associated with the identified powered device. Step 1010 freezes the device configuration, and checks for the configuration in power management module 30 in step 1011, checks status by polling in step 1012, and checks interrupt discrete in step 1013. In step 1014, the definition is forwarded to power management module 30 for adjusting the power, voltage and/or current levels of the power supply to correspond to the requirements of the powered device.

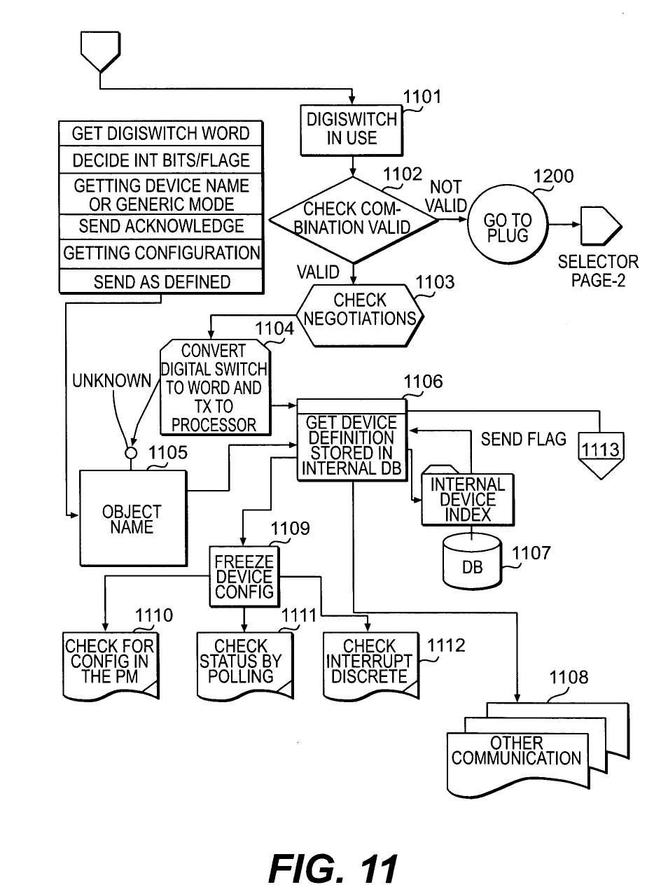

If the SM-bus is not valid in step 1002, the digi switch is queried in step 1100. The digi swicth port query is graphically illustrated in FIG. 11. The digi switch signal is received at step 1101, and a query of whether the combination is valid occurs at step 1102. When the combination is valid, the negotiation is checked in step 1103. A digital switch is converted to a word and transmitted to the processor in step 1104. The device name associated with the word is retrieved in order to identify the object (powered device) in step 1105, which requires user interaction. The database receives the word and retrieves the device name or generic mode associated with the word. An acknowledgement is made and the configuration is retrieved and sent. The identity of the powered device is forwarded in step 1106 to obtain, through an internal device index, the definition stored in the database associated with the powered device in step 1107. It may be necessary to access other communications in step 1108 in order to obtain the definition associated with the powered device. Step 1109 freezes the device configuration, and checks for the configuration in power management module 30 in step 1110, checks status by polling in step 1111, and checks interrupt discrete in step 1112. In step 1113, the definition is forwarded to power management module 30 for adjusting the power, voltage and/or current levels of the power supply to correspond to the requirements of the powered device.

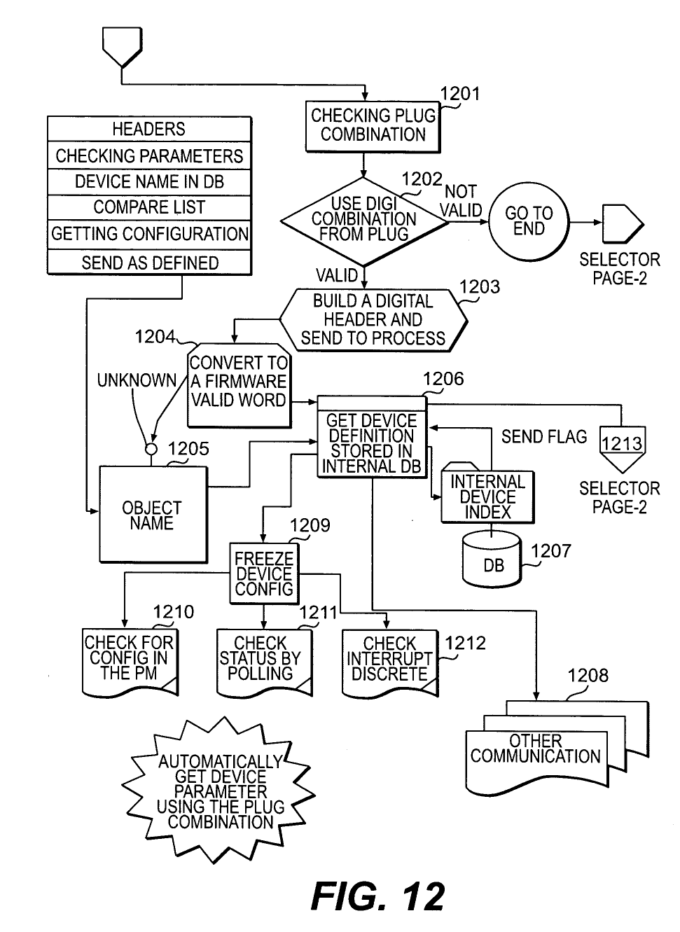

If the digi switch is not valid in step 1102, the plug connector is queried in step 1200. The plug connector port query is graphically illustrated in FIG. 12. The plug connection is checked at step 1201, and a query is made whether to use the digital combination from the plug at step 1202. When the plug combination is valid, a digital header is built and sent to the processor in step 1203. The digital header is converted to a firmware readable word in step 1204 into order to identify the object (powered device) in step 1205, which is obtained automatically without requiring user interaction. The database accesses the headers and checks parameters to determine whether the device name is in the database. A compare list is generated and the selected configuration is retrieved. The identity of the powered device is forwarded in step 1206 to obtain, through an internal device index, the definition stored in the database associated with the powered device in step 1207. It may be necessary to access other communications in step 1208 in order to obtain the definition associated with the powered device. Step 1209 freezes the device configuration, and checks for the configuration in power management module 30 in step 1210, checks status by polling in step 1211, and checks interrupt discrete in step 1212. In step 1213, the definition is forwarded to power management module 30 for adjusting the power, voltage and/or current levels of the power supply to correspond to the requirements of the powered device.

Returning to FIG. 5, once the communication port is selected, the powered device is identified. The parameters of the powered device are forwarded to power management module in step 517 so that the voltage, current, and/or power supplied to the powered device by the fuel cell in step 518 or by the battery in step 519 matches the requirements of the powered device.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An apparatus to couple a power source to a powered device, comprising:
a power manager structured and arranged to adjust at least one of voltage, current and power supplied from the power source to the powered device based upon consumption requirements of the powered device; and
a device coordinator structured and arranged to identify the powered device and to forward the identified device's consumption requirements for at least one of voltage, current and power to said power manager.

2. The apparatus in accordance with claim 1, further comprising a plurality of communications ports.

3. The apparatus in accordance with claim 2, wherein the powered device is coupled to said device coordinator through said plurality of communications ports.

4. The apparatus in accordance with claim 3, wherein the communications ports receive communication via at least one of infrared, bluetooth, SM-bus, RS-232, USB, and digital switch.

5. The apparatus in accordance with claim 4, wherein the powered device is automatically identified through use of the SM-bus.

6. The apparatus in accordance with claim 1, further comprising at least one plug connector to couple said device coordinator to the powered device.

7. The apparatus in accordance with claim 1, wherein an encoded plug is insertable into said at least one plug connector, whereby decoding of the plug by said device coordinator automatically identifies the powered device.

8. The apparatus in accordance with claim 1, wherein the power source is at least one of an ac power source and a dc power source.

9. The apparatus in accordance with claim 1, wherein the powered device comprises a mobile equipment.

10. The apparatus in accordance with claim 9, wherein the mobile equipment comprises at least one of a laptop/notebook computer, digital camera, personal digital assistant (PDA), cellular telephone, and video camera.

11. The apparatus in accordance with claim 1, wherein said power manager comprises:
a dc/dc converter structured and arranged to adjust at least one voltage and current from the power supply to be supplied to the powered device.

12. The apparatus in accordance with claim 11, said power manager further comprising:
an up converter structured and arranged to boost at least one of voltage and current from said dc/dc converter to be supplied to the powered device.

13. The apparatus in accordance with claim 11, wherein said power manager further comprises:
a backup battery to supply additional power to the powered device when necessary to supplement the power supply.

14. The apparatus in accordance with claim 13, further comprising an up converter structured and arranged to boost the output of the backup battery to the powered device.

15. A process for supplying at least one of voltage, current and power from a power supply to a powered device, comprising:
coupling the power supply and powered device through a connection device;
identifying consumption requirements of the powered device through communication between the powered device and the connection device; and
adjusting the at least one of voltage, current and power supplied by the power source to the powered device in accordance with the consumption requirements.

16. The process in accordance with claim 15, wherein the communication between the powered device and the connection device is through one of infrared, bluetooth, SM-bus, RS-232, USB, and digital switch.

17. The process in accordance with claim 16, wherein the powered device is automatically identified through use of the SM-bus.

18. The process in accordance with claim 15, wherein the communication between the powered device and the connection device is through an encoded plug that automatically identifies the powered device.

19. The process in accordance with claim 15, wherein the power source is at least one of an ac power source and a dc power source.

20. A process for connecting a power supply to a powered device through the apparatus in accordance with claim 1, comprising:
coupling the power supply and powered device through the power manager;
identifying consumption requirements of the powered device through communication between the powered device and the device coordinator; and
adjusting, via the power manager, at least one of voltage, current and power supplied by the power source to the powered device in accordance with the consumption requirements identified by the device coordinator.
